(19) United States
(12) Patent Application Publication
(10) Pub. No.: US 2006/0079405 A1
(43) Pub. Date: Apr. 13, 2006

(54) Well drilling and servicing fluids with magnesia bridging solids and methods of drilling, completing and working over a well therewith

(76) Inventors: James W. Dobson JR., Houston, TX (US); Kim O. Tresco, Houston, TX (US); Jorge M. Fernandez, Houston, TX (US); Bradley L. Todd, Duncan, OK (US); Trinidad Munoz JR., Duncan, OK (US)

Correspondence Address: ROY F. HOUSE, 5726 ETTRICK STREET, HOUSTON, TX, 77035, US

(21) Appl. No.: 10/530,793

(22) PCT Filed: Oct. 8, 2004
(86) PCT No.: PCT/US04/33237

§ 371 Date: Apr. 8, 2005

(51) Int. Cl. C09K 8/08; E21B 43/00

(52) U.S. Cl. 507/110; 507/213

(57) ABSTRACT

The invention provides well drilling and servicing fluids, and methods of drilling, completing, or working over a well therewith, preferred fluids comprise an aqueous liquid, a water soluble polymer viscosifier (preferably xanthan gum), a polymeric fluid loss control additive (preferably a partially depolymerized partially crosslinked hydroxyalkyl ether derivative of starch or a hydroxyalkyl ether derivative of a partially crosslinked and partially depolymerized starch), and as a bridging agent a particulate magnesia that has an Activity Index greater than about 800 seconds, preferably from about 800 seconds to about 3000 seconds.

### BACKGROUND OF THE INVENTION

The present invention relates to clay-free aqueous well drilling and servicing fluids, methods of preparation thereof, and methods of drilling or servicing a well therewith.

The use of fluids for conducting various operations in the boreholes of oil and gas wells which contact a hydrocarbon-containing subterranean formation are well known. Thus, drill-in fluids are utilized when initially drilling into potential hydrocarbon producing formations. Completion fluids are utilized when conducting various completion operations in the hydrocarbon-containing formations. Workover fluids are utilized when conducting workover operations of previously completed wells.

It is important that the fluids which contact hydrocarbon-containing formations are formulated such that there is a minimum penetration of fluid, both the aqueous phase and the solid phase, into the formation. Thus, the present state-of-the-art fluids generally comprise a “water soluble” polymer, preferably a biopolymer such as xanthan gum or scleroglucan gum, starch derivatives for fluid loss control, and water soluble or acid soluble bridging agents to form a thin filter cake which forms a protective seal of the formation. See for example the following U.S. Patents, incorporated herein by reference: Mondshine U.S. Pat. No. 4,620,596; Dobson, Jr. et al. U.S. Pat. No. 4,822,500; Dobson, Jr. et al. U.S. Pat. No. 5,629,271; Dobson, Jr. et al. U.S. Pat. No. 5,641,728; Dobson, Jr. et al. U.S. Pat. No. 5,728,652; and Dobson, Jr. et al. U.S. Pat. No. 5,804,535. A recent development is a biopolymer-free fluid which utilizes a unique amylopectin starch derivative for both viscosity development and fluid loss control as set forth in Dobson, Jr. et al. U.S. Pat. No. 6,391,830.

After the well has been drilled and completed, it is necessary to remove the filter cake from the surface of the formation allowing the hydrocarbons therein to flow to the wellbore for production. This is generally aided by contacting the filter cake with various washes/soak solutions in which the components of the filter cake are soluble, most generally acidic aqueous fluids. See, for example, the following U.S. patents, incorporated herein by reference: Mondshine et al. U.S. Pat. No. 5,238,065; Dobson, Jr. et al. U.S. Pat. No. 5,607,905; Dobson, Jr. et al. U.S. Pat. No. 5,783,527; and Dobson, Jr. et al. U.S. Pat. No. 5,783,526.

As indicated in Mondshine U.S. Pat. No. 4,620,596, sparingly soluble borates have been utilized as bridging agents in well drilling and servicing fluids. However, one problem with their use in biopolymer-containing fluids is the crosslinking of the biopolymers that occurs when the borate anion reacts with the biopolymers. Thus, there is a need for another bridging agent that is sparingly soluble in water/aqueous systems and is soluble in acidic solutions.

Powdered magnesium oxide is utilized in the art as an alkalinity control additive for biopolymer-containing fluids as exemplified by the U.S. patents referenced hereinbefore.

The magnesium oxide as referenced in Dobson, Jr. et al. U.S. Pat. No. 5,514,644, incorporated herein by reference, has an Activity Index less than about 100 seconds, most preferably less than about 50 seconds.

We have investigated the use of particulate, sized magnesium oxide as a bridging agent in biopolymer-containing fluids and found that the increased concentrations of the magnesium oxide needed for proper filter cake development (i.e., bridging) generates a gelatinous mass after thermal aging of the fluids.

The present invention pertain to stable well drilling and servicing fluids which provide a filter cake that is partially water soluble and substantially acid soluble for improved removal from the sides of the borehole/face of the hydrocarbon-containing formations on which the filter cake is deposited.

### SUMMARY OF THE INVENTION

We have now found that calcined (so-called “deadburned”) magnesia which has an Activity Index greater than about 800 seconds provides biopolymer-containing well drilling and servicing fluids which do not gel on thermal aging at temperatures at which the biopolymer does not decompose and which utilizes the particulate, sized magnesia particles as a bridging agent to form the required thin filter cake to limit fluid invasion into the hydrocarbon-containing formation contacted by the fluid.

The present invention provides a stable water soluble polymer-containing well drilling and servicing fluid which utilizes as a bridging agent particulate, sized calcined magnesia which has an Activity Index greater than about 800 seconds.

The present invention provides a method of drilling a well wherein there is circulated within the wellbore being drilled as drilling proceeds a water base drilling fluid containing as a bridging agent particulate, sized calcined magnesia which has an Activity Index greater than about 800 seconds.

The present invention further provides a process of completing or working over a well wherein a subterranean formation is contacted with an aqueous fluid wherein the fluid contains a bridging agent comprising a particulate, sized magnesia which has an Activity Index greater than about 800 seconds.

Other objects, features and embodiments of the invention are disclosed in the following description of the invention and appended claims.

While the invention is susceptible to various modifications and alternative forms, specific embodiments thereof will hereinafter be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

The compositions can comprise, consist essentially of, or consist of the stated materials. The method can comprise, consist essentially of, or consist of the stated steps with the stated materials.

### DETAILED DESCRIPTION OF THE INVENTION

The present invention is based on the principle that particulate, sized calcined magnesia which has an Activity Index greater than about 800 seconds can be utilized as a partially water soluble, completely acid soluble bridging agent in well drilling and servicing fluids (hereinafter sometimes referred to as “WDSF”).

The Activity Index of magnesia is obtained using the following apparatus and test procedures.

The rate at which magnesium oxide reacts with a dilute solution of acetic acid is used as a measure of activity. An excess of magnesia is used so that at the end point of the reaction, the solution goes from acidic to basic and is detected by a color change employing phenolphthalein indicator.

Apparatus and Reagents:

Acetic acid solution 1.00±0.01N, standardized

Phenolphthalein soln. (1% solution in ethanol)

Waring blender, 2 speed with 32 oz. glass container

Balance with sensitivity of 0.01 gm

Stopwatch

Thermometer

Graduated cylinders, 100 ml and 500 ml

Procedure
1. Prior to the test, the water and the acetic acid solution should be brought to a temperature of 25±1 C.
2. Weigh a 5.00±0.02 grams aliquot of the magnesia sample.
3. Measure out 300 ml of water in a graduated cylinder and add it to the blender.
4. Carefully hold a thermometer in the blender and run blender until the temperature of the water is 28° C. Turn off the blender.
5. Add 5-10 drops of phenolphthalein indicator solution.
6. Add the magnesia sample and immediately start the blender on low speed.
7. Count ten seconds from the start of the blender and add 100 ml of the 1.00N acetic acid solution. The stopwatch is started as the acid is being added.
8. Stop the timer when the solution turns to a definite pink color. Record the reaction time in seconds as the activity index of the magnesia.
9. Note: Add three to five additional drops of indicator solution to the blender every 30 seconds until the color change has taken place.

Magnesia having an Activity Index less than about 800 seconds is too water soluble producing biopolymer-containing fluids which become gelatinous on heating.

The WDSF of the invention comprise one or more polymer viscosifier/suspension agents, one or more polymeric fluid loss control agents, and the magnesia bridging agent dispersed in an aqueous liquid.

The preferred polymer viscosifier is a biopolymer (microbial polysaccharide). The term “biopolymer” is intended to mean an excellular polysaccharide of high molecular weight, in excess of about 500,000, produced by fermentation of a carbohydrate source by the action of bacteria or fungi.

Representative microorganisms are the genus Xanthomonas, Pseudomonas, Agrobacterium, Arthrobacter, Rhizobium, Alcaligenes, Beijerincka, and Sclerotium. A scleroglucan type polysaccharide produced by microorganisms such as NCIB 11592 and NCIB 11883 is commercially available from Degussa.

The preferred biopolymer viscosifier useful in the practice of this invention is preferably a xanthomonas gum (xanthan gum). Xanthomonas gum is available commercially from Rhodia under the tradename VISULTRA. It is a widely used viscosifier and suspending agent in a variety of fluids. Xanthomonas gum can be made by the fermentation of carbohydrate with bacteria of the genus Xanthomonas. Representative of these bacteria are Xanthomonas campestris, Xanthomonas phaseoli, Xanthomonas mulvacearn, Xanthomonas carotoe, Xanthomonas traslucens, Xanthomonas hederae, and Xanthomonas papavericoli. The gum produced by the bacteria Xanthomonas campestris is preferred for the purpose of this invention. The fermentation usually involves inoculating a fermentable broth containing a carbohydrate, various minerals and a nitrogen yielding compound. A number of modifications in the fermentation procedure and subsequent processing are commercially used. Due to the variety of fermentation techniques and difference in processing operation subsequent to fermentation, different production lots of xanthomonas gum will have somewhat different solubility and viscosity properties. Xanthomonas gums useful in the practice of the present invention are relatively hydratable xanthomonas gums.

Xanthan gum is a polymer containing mannose, glucose, glucuronic acid salts such as potassium glucuronate, sodium glucuronate, or the like, and acetyl radicals. Other Xanthomonas bacteria have been found which produce the hydrophilic gum and any of the xanthan gums and their derivatives can be used in this invention. Xanthan gum is a high molecular weight linear polysaccharide that is readily soluble in water to form a viscous fluid.

Other biopolymers prepared by the action of other bacteria, or fungi, on appropriate fermentation mediums may be used in the fluids of the present invention provided that they impart the desired thermally stable Theological characteristics thereto. This can be readily determined by one skilled in the art in accordance with the teachings of this specification.

Polymeric fluid loss control additives used in well drilling and servicing fluids are so-called water soluble polymers including pregelatinized starch, starch derivatives, cellulose derivatives, lignocellulose derivatives, and synthetic polymers.

Representative starch derivatives include: hydroxyalkyl starches such as hydroxyethyl starch, hydroxypropyl starch, hydroxypropyl carboxymethyl starch, the slightly crosslinked derivatives thereof, and the like; carboxymethyl starch and the slightly crosslinked derivatives thereof; cationic starches such as the tertiary aminoalkyl ether derivatives of starch, the slightly crosslinked derivatives thereof, and the like. Representative cellulose derivatives include low molecular weight carboxymethyl cellulose, and the like. Representative lignocellulose derivatives include the alkali metal and alkaline earth metal salts of lignosulfonic acid and graft copolymers thereof. Representative synthetic polymers include vinyl sulfonate copolymers, and polymers containing other sulfonate monomers.

The preferred polymeric fluid loss control additives used in the invention are the starch ether derivatives such as hydroxyethyl starch, hydroxypropyl starch, dihydroxypropyl starch, carboxymethyl starch, hydroxyalkyl carboxymethyl starch, and cationic starches, and the slightly crosslinked derivatives of these starch ethers, most preferably the hydroxypropyl ether derivative of starch and the slightly crosslinked derivatives thereof.

Most preferably the polymeric fluid loss control additive is a starch ether derivative which has been slightly crosslinked, such as with epichlorohydrin, phosphorous oxychloride, soluble trimetaphosphates, linear dicarboxylic acid anhydrides, N,N¹-methylenebisacrylamide, and other reagents containing two or more functional groups which are able to react with at least two hydroxyl groups. The preferred crosslinking reagent is epichlorohydrin. Generally, the treatment level is from about 0.005% to about 0.1% of the starch to give a low degree of crosslinking of about one crosslink per 200 to 1000 anhydroglucose units. The crosslinking may be undertaken before or after the starch is derivatized. Additionally, the starch may be modified by acid or enzyme hydrolysis or oxidation, to provide a lower molecular weight, partially depolyermized, starch polymer for derivatization. Alternatively, the starch ether derivative may be modified by acid hydrolysis or oxidation to provide a lower molecular weight starch ether derivative. The book entitled “Modified Starches: Properties and Uses,” by O. B. Wurzburg, 1986 (CRC Press, Inc., Boca Raton, Fla., U.S.A.) is an excellent source for information in the preparation of starch derivatives.

Still most preferably, the polymeric fluid loss additive is a starch derivative selected from the group consisting of (1) a crosslinked ether derivative of a partially hydrolyzed starch, (2) a partially depolymerized, crosslinked ether derivative of starch, and (3) mixtures thereof, as set forth in Dobson, Jr. et al. U.S. Pat. No. 5,641,728, incorporated herein by reference.

In case (1) the starch is partially depolymerized prior to crosslinking and derivatizing the starch, whereas in the latter case (2) the starch is first crosslinked and derivatized prior to partially depolymerizing the starch derivative. In either case, the molecular weight of the crosslinked starch derivative is decreased by the partial depolymerization of the starch polymer. As used throughout this specification and claims, the terms “partially depolymerized starch derivative,” and “hydrolyzed starch derivative” and the like are intended to mean the starch derivatives prepared by either case (I) or case (2).

In case (1), it is preferred that the starch be hydrolyzed or depolymerized to the extent that the viscosity of an aqueous dispersion of the starch is reduced about 25% to about 92%, preferably about 50% to about 90%, prior to crosslinking and derivatizing the starch. In case (2), it is preferred that the crosslinked starch derivative be hydrolyzed or depolymerized to the extent that the viscosity of a water dispersion of the starch derivative at a concentration of 60 kg/m³ is reduced about 15% to about 50%, preferably about 20% to about 40%.

Patents which disclose oxidative processes for partially depolymerizing starch derivatives and/or starches include the following, incorporated herein by reference: U.S. Pat. No. 3,975,206 (Lotzgesell et al.); U.S. Pat. No. 3,935,187 (Speakman); U.S. Pat. No. 3,655,644 (Durand). Patents which disclose acidic processes for partially depolymerizing starch derivatives and/or starches include the following, incorporated herein by reference: U.S. Pat. No. 3,175,928 (Lancaster et al.); U.S. Pat. No. 3,073,724 (Rankin et al.). Reference information on the acid modification of starches is presented in “Starch: Chemistry and Technology” 2nd Edition, 1984, Roy L. Whistler, James N. Bemiller and Eugene F. Paschall, editors, Chapter XVII, pp. 529-541, “Acid-Modified Starch: Production and Uses.”

The partially depolymerized or hydrolyzed starch in case (1) or the starch in case (2) is crosslinked with a compound the molecules of which are capable of reacting with two or more hydroxyl groups. Representative crosslinking materials are epichlorohydrin and other epihalohydrins, formaldehyde, phosphorous oxychloride, trimetaphosphate, dialdehydes, vinyl sulfone, diepoxides, diisocyanates, bis(hydroxymethyl) ethylene urea, and the like. The preferred crosslinking compound is epichlorohydrin. Crosslinking of the starch (or hydrolyzed starch) results in an increase in the molecular weight of the starch and an increase in the viscosity of aqueous dispersions of the starch.

The reaction conditions used in making crosslinked starches vary widely depending upon the specific bi-or polyfunctional reagent used for the crosslinking. In general, most of the reactions are run on aqueous suspensions of starch at temperatures ranging from room temperature up to about 50° C. Often an alkali such as sodium hydroxide is used to promote reaction. The reactions are normally run under neutral to fairly alkaline conditions, but below the level which will peptize or swell the starch. If the crosslinking reaction is run in an aqueous suspension of starch, when the desired level of crosslinking (usually as measured by some type of viscosity or rheology test) is reached, the starch suspension is neutralized and the starch is filtered and washed to remove salts, any unreacted reagent, and other impurities produced by side reactions of the crosslinking reagent with water. Konigsberg U.S. Pat. No. 2,500,950 discloses the crosslinking of starch with epoxyhalogen compounds such as epichlorohydrin.

It is preferred that the starch or hydrolyzed starch for use in the present invention be crosslinked with epichlorohydrin in a basic aqueous starch suspension at a temperature and for a period of time such that the Brabander viscosity of the suspension is within about 50% to 100% of the maximum viscosity. The viscosity will vary by the amount of crosslinking and the test conditions, i.e., temperature, concentrations, etc. A viscosity peak indicates maximum crosslinking. When the desired viscosity is reached, the crosslinking reaction is terminated. A Brabender viscometer is a standard viscometer readily available on the open market and well known to those skilled in the art.

Generally, the treatment level is from about 0.005% to about 0.1% of starch to give a low degree of crosslinking of about one crosslink per 200 to 1000 anhydroglucose units. As indicated, the crosslinking may be undertaken before or after the starch is derivatized.

The epichlorohydrin crosslinked starch is then preferably reacted with propylene oxide to form the hydroxypropyl ether. The reaction of propylene oxide and starch is base catalyzed. Aqueous slurry reactions are generally catalyzed by 0.5 to 1% sodium hydroxide based on the dry weight of starch. Sodium sulfate or sodium chloride may be added to keep the starch from swelling during reaction with the propylene oxide. Reaction temperatures are generally in the range of from about 37.7° C. to about 51.7° C. (100° to 125° F.). Propylene oxide levels generally range from about 1% to about 10% based on the dry weight of the starch. Propylene oxide-starch reactions take approximately 24 hours to complete under the conditions described and are about 60% efficient with respect to the propylene oxide. It is preferred that the epichlorohydrin crosslinked hydroxypropyl ether contain from about 0.5% to about 5% reacted propylene oxide based on the dry weight of starch or hydrolyzed starch.

Other methods of preparing epichlorohydrin crosslinked starches and hydroxypropyl starch ethers are well known in the art.

The preferred starch ether derivative as indicated is the hydroxypropyl ether. Other representative starch derivatives are hydroxyethyl ethers, carboxymethyl ethers, dihydroxypropyl ethers, hydroxyalkyl carboxymethyl ethers, and cationic starch ethers. The preparation of such starch derivatives is well known in the art.

The particle size distribution of the magnesia bridging agent must be sufficient to bridge across and seal the pores in the subterranean formation contacted by the fluid, all as is well known in the art. Generally, as disclosed in U.S. Pat. No. 4,175,042, incorporated herein by reference, the particle size range is from about 5 microns to about 800 microns with greater than about 5% by weight of the particles being coarser than about 44 microns. However, as indicated in Dobson, Jr. et al. U.S. Pat. No. 5,629,271, incorporated herein by reference, the addition of a supplementary bridging agent having a particle size such that at least 90% of the particles thereof are less than 10 microns and the average particle size is from about 3 to about 5 microns decreases the fluid loss of the fluids and reduces the concentration of polymer required to impart the desired degree of fluid loss control to the fluids. This in effect increases the concentration of particles less than 10 microns diameter in the fluid.

Since the particle size distribution of the bridging agent needed in any well drilling and servicing operation is related to the size of the openings in the formations to be bridged and sealed, it is preferred to have several particulate, sized magnesia products having different particle size distributions which can be blended to produce fluids effective in sealing the formations contacted by the fluids.

The aqueous liquid used to prepare the WDSF of this invention may be any liquid compatible with the polymeric viscosifier and the polymeric fluid loss control additive used to prepare the WDSF. Thus, the aqueous liquid may be natural or a synthetic brine having one or more water soluble salts dissolved therein. Exemplary water soluble salts well known in the art are sodium chloride, calcium chloride, potassium chloride, sodium bromide, calcium bromide, potassium bromide, zinc bromide, sodium formate, potassium formate, cesium formate, and other water soluble salts as desired. Generally, the concentration of water soluble salts in the aqueous brine may be any concentration up to saturation in order to provide the aqueous liquid with the density desired, such as from 8.3 ppg (1000 kg/m³) to about 19.2 ppg (2304 kg/m³).

The fluids of this invention are further characterized in Table A.

TABLE A

| | | | Most |
|---|---|---|---|
| | Operable | Preferred | Preferred |
| Water Soluble Polymer Viscosifier, | 1.03-14.3 | 2.14-11.4 | 2.85-8.56 |
| kg/m³ | | | |
| Fluid Loss Control Additive, kg/m³ | 5.7-42.8 | 8.5-28.5 | 11.4-22.8 |
| Magnesia Bridging Agent, kg/m³ | 42.8-286 | 51-228 | 71-171 |
| Low Shear Rate Viscosity, cp* | >10,000 | >15,000 | >20,000 |
| Spurt Loss, ml* | <5 | <3 | <3 |
| 30-Minute Fluid Loss, ml* | <15 | <10 | <10 |

*Determined as disclosed hereinafter

The fluids of the invention may be prepared and the method of the invention practiced, by mixing the aqueous liquid as set forth herein with the polymeric viscosifier, the polymer fluid loss control additive, and the bridging agent, and any optional additives as desired.

The fluids of the invention are useful in various petroleum recovery operations such as well drilling, including drilling into hydrocarbon-containing formations, completion, workover and the like all as are well known in the art. Specifically the fluids of the invention are useful in drilling a well wherein the drilling fluid is circulated within a borehole being drilled as drilling proceeds, and in well completion and workover methods wherein a subterranean formation is contacted with an aqueous fluid to form a bridge and seal on the formation, all as are well known in the art.

The low shear rate viscosity (LSRV) for purposes of this invention is obtained using a Brookfield Model LVTDV-1 viscometer having a number 1 or 2 spindle at 0.3 revolutions per minute (shear rate of 0.0636 sec⁻¹). The fluid loss characteristics of the fluids are obtained by a modified API filtration test. Thus, to an API high temperature filtration cell with removable end cages is added a 5 micron disk (i.e., an aluminum oxide Aloxite™ ceramic disk having 5 micron pore throats, from 600 to 750 md permeability, which is 2.5 inches in diameter and 0.25 inch in depth) saturated with water. The fluid to be tested is poured along the inside edge of the filtration cell. The filtration test is then conducted for 30 minutes at the desired temperature of 150° F. under a pressure differential of 250 pounds per square inch supplied by nitrogen. The spurt loss is measured as the amount of fluid expelled from the filtration cell until the flow of fluid is reduced to drops. The fluid loss is measured as the total amount of fluid collected in 30 minutes.

The Fann viscosity data is obtained utilizing a Fann 35 viscometer in accordance with the procedures set forth in API Recommended Practice RP-13B-1.

The typical particle size distribution of these calcined, particulate, sized agnesia products utilized in the examples to follow is set forth in Table B. The ctivity Index of these products is as follows: Magnesia A—840 seconds; agnesia B—1410 seconds; Magnesia C—1740 seconds.

TABLE B
Typical Volume % of Particles Under the Indicated Size

| Particle Size, microns | Magnesia A | Magnesia B | Magnesia C |
|---|---|---|---|
| 3.09 | 26.81 | 17.49 | 10.23 |
| 5.03 | 43.36 | 27.71 | 17.53 |
| 5.86 | 50* | — | — |
| 9.86 | 76.02 | 46.72 | 30.79 |
| 10.82 | — | 50* | — |
| 15.12 | 92.97 | 63.12 | 41.67 |
| 19.75 | — | — | 50* |
| 20.52 | 98.88 | 76.42 | 51.3 |
| 26.2 | 100 | 86.15 | 60.22 |
| 35.56 | 100 | 95.0 | 72.66 |
| 44 | 100 | 98.5 | 81.3 |
| 57.97 | 100 | 100 | 90.72 |
| 106.8 | 100 | 100 | 100 |

*Medium particle size (D₅₀)

The particle size of the magnesia is determined with a Malvern Instruments' MASTERSIZER particle size analyzer. The preferred particle size of the calcined magnesia has an average particle size (D₅₀) from about 5 microns to about 50 microns.

The Activity Index of the calcined magnesia decreases as the particle size decreases. The Activity Index of the calcined magnesia before grinding and sizing for the magnesia samples A, B, and C was greater than 40 minutes. Calcined magnesia having a median particle size (D₅₀) of 30, 50 and 150 microns has an Activity Index of 1890, 2940, and 5610 seconds, respectively. The preferred calcined magnesia has an Activity Index from about 800 seconds to about 3000 seconds.

In order to more completely describe the invention, the following non-limiting examples are given. In these examples and this specification, the following abbreviations may be used: API=American Petroleum Institute; LSRV=Brookfield low shear rate viscosity at 0.03 revolutions per minute, 0.0636 sec⁻¹, in centipoise; sec=second(s); ppg=pounds per gallon; ppb=pounds per 42 gallon barrel; ° C.=degrees Centrigrade; ° F.=degrees Fahrenheit; g=grams; ml=milliliters; min=minutes; cp=centipoise; Pa=pascal; kg/m³=kilograms/cubic meter; rpm=revolutions per minute; in =inches; sq.ft.=square feet; GS=gel strength.

### EXAMPLE 1

Well drilling and servicing fluids were prepared containing 339.5 ml of a 1200 kg/m³ (10.0 ppg) NaCl brine, and the concentrations of xanthan gum, starch derivative A, and Magnesias A, B, and C set forth in Table 1. The initial properties and the properties after static-aging the fluids for 16 hours at 65.5° C. (150° F.) were determined. The data obtained is set forth in Table 1. The data indicate the excellent stability of the fluids.

Starch derivative A is available from TBC-Brinadd, Houston, Tex., as BROMA FLA.

### EXAMPLE 2

Well drilling and servicing fluids were prepared containing 336 ml of a 1200 kg/m³ (10.0 ppg) NaCl brine, 1.25 g xanthan gum, 4.0 g starch derivative B, and the concentrations of Magnesias A, B, and C set forth in Table 2. Starch derivative B is FL-7+available from TBC-Brinadd, Houston, Tex.

TABLE 1

| | Fluid | | |
|---|---|---|---|
| | 1-1 | 1-2 | 1-3 |
| Xanthan Gum, g | 1.25 | 1.25 | 1.0 |
| Starch Derivative A, g | 4.0 | 5.0 | 6.0 |
| Magnesia A, g | 7.8 | 7.8 | 15.6 |
| Magnesia B, g | 7.8 | 7.8 | 5.2 |
| Magnesia C, g | 10.4 | 10.4 | 5.2 |

Initial Properties

| | | | |
|---|---|---|---|
| PV, cp | 14 | 16 | 16 |
| YP, Pa | 11.5 | 12.96 | 10.56 |
| 10-Sec GS, Pa | 4.8 | 4.8 | 3.36 |
| 10-Min, GS, Pa | 6.24 | 6.72 | 4.8 |
| LSRV, cp | 19,700 | 26,800 | 16,600 |
| pH | 10.27 | 10.29 | 10.22 |
| Fluid | | | |
| Spurt Loss, ml | 2.5 | 2.0 | 2.0 |
| 30 min., ml | 6.5 | 6.5 | 6.0 |

Properties After Static Aging at 65.5° C. (150° F.) for 16 Hours

| | | | |
|---|---|---|---|
| PV, cp | 14 | 19 | 19 |
| YP, Pa | 9.6 | 12.96 | 12.96 |
| 10-Sec GS, Pa | 3.84 | 5.28 | 4.32 |
| 10-Min, GS, Pa | 5.76 | 7.2 | 6.24 |
| LSRV, cp | 19,000 | 25,800 | 19,500 |
| pH | 10.76 | 10.95 | 10.94 |
| Fluid Loss | | | |
| Spurt Loss, ml | 2.0 | 2.0 | 2.0 |
| 30 min., ml | 8.5 | 7.0 | 7.5 |
| Gelation | None | None | None |
| Settling | None | None | None |
| Separation | None | None | None |

TABLE 2

| | Fluid | | |
|---|---|---|---|
| | 2-1 | 2-2 | 2-3 |
| Xanthan Gum, g | 1.25 | 1.25 | 1.25 |
| Starch Derivative B, g | 4.0 | 5.0 | 4.0 |
| Magnesia A, g | 9.6 | 12 | 4.8 |
| Magnesia B, g | 0 | 0 | 4.8 |
| Magnesia C, g | 38.4 | 36 | 38.4 |

Properties After Static Aging at 65.5° C. (150° F.) for 16 Hours

| | | | |
|---|---|---|---|
| PV, cp | 19 | 24 | 20 |
| YP, Pa | 13.44 | 17.28 | 14.88 |
| 10-Sec GS, Pa | 5.28 | 6.24 | 5.76 |
| 10-Min, GS, Pa | 6.72 | 7.2 | 7.2 |
| LSRV, cp | 28,100 | 36,100 | 33,700 |
| pH | 10.20 | 10.60 | 10.47 |
| Fluid Loss | | | |
| Spurt Loss, ml | 2.0 | 2.0 | 2.0 |
| 30 min., ml | 11.5 | 9.5 | 10.5 |
| Gelation | None | None | None |
| Settling | None | None | None |
| Separation | None | None | None |

### EXAMPLE 3

A well drilling and servicing fluid was prepared containing 339.5 ml (0.97 bbl equivalent) of a 1440 kg/m³ (12.0 ppg) NaBr brine, 1.25 g of xanthan gum, 4.0 g of starch derivative B, 7.8 g of Magnesia A, and 18.2 g of Magnesia C. The initial properties and properties after hot rolling 16 hours at 65.5° C. (150° F.) and cooling to ambient temperature are set forth in Table 3.

TABLE 3

| | INITIAL | AFTER HOT ROLLING |
|---|---|---|
| PV, cp | 17 | 22 |
| YP, Pa | 13.44 | 14.88 |
| 10-Sec. GS, Pa | 5.76 | 5.76 |
| 10-Min. GS, Pa | 7.68 | 10.08 |
| LSRV, cp | 37,800 | 52,900 |
| pH | 9.38 | 10.27 |
| Fluid Loss | | |
| Spurt Loss, ml | — | 2.0 |
| 30-Min., ml | — | 8.5 |

### EXAMPLE 4

Well drilling and servicing fluids were prepared in a 1200 kg/m³ (10.0 ppg) NaCl brine containing 3.57 kg/m³ (1.25 ppb) xanthan gum, 11.4 kg/m³ (4.0 ppb) starch derivative A, and a total of 74.2 kg/m³ (26 ppb) magnesia of different particle size distribution as indicated in Table 4. The fluids were evaluated for fluid loss control. The data demonstrates that increasing the concentrations of the finer (smaller) bridging particles decreases the fluid loss at 26 ppb total bridging solids.

TABLE 4

| | 4-1 | 4-2 | 4-3 | 4-4 | 4-5 |
|---|---|---|---|---|---|
| Fluid | | | | | |
| Magnesia A, kg/m³ | 7.4 | 18.5 | 22.25 | 29.7 | 44.5 |
| Magnesia B, kg/m³ | 7.4 | 18.5 | 22.25 | 29.7 | 14.8 |
| Magnesia C, kg/m³ | 59.3 | 37.1 | 29.7 | 14.8 | 14.8 |
| Fluid Loss | | | | | |
| Spurt Loss, ml | 3.0 | 3.0 | 2.0 | 2.0 | 2.0 |
| 30-Min., ml | 8.0 | 8.0 | 6.5 | 6.5 | 6.0 |

### EXAMPLE 5

Example 4 was repeated except that the fluids contained a total of 42.8 kg/m³ (15 ppg) magnesia bridging solids.

TABLE 5

| | Fluid | | |
|---|---|---|---|
| | 5-1 | 5-2 | 5-3 |
| Magnesia A, kg/m³ | 21.4 | 14.265 | 12.8 |
| Magnesia B, kg/m³ | 10.7 | 14.265 | 0 |
| Magnesia C, kg/m³ | 10.7 | 14.265 | 29.95 |
| Fluid Loss | | | |
| Spurt Loss, ml | 2.5 | 2.0 | 3.5 |
| 30-Min., ml | 7.5 | 6.5 | 8.5 |

### EXAMPLE 6

Well drilling and servicing fluids were prepared containing 336 ml of a 1200 kg/m³ (10.0 ppg) NaCl brine, 1.25 g xanthan gum, 4.0 g of the starch derivatives indicated in Table 6, and a total of 48 g of magnesia bridging solids as indicated in Table 6. Starch derivative C EMFLOC HCKLV available from TCM Chemicals, Inc. and starch derivative D is EMFLOC SXT available from TCM Chemicals, Inc.

Starch derivative E is DRILSTAR HT available from Chemstar.

TABLE 6

| | Fluid | | | |
|---|---|---|---|---|
| | 6-1 | 6-2 | 6-3 | 6-4 |
| Starch Derivative | A | C | D | E |
| Magnesia A, g | 9.6 | 12 | 12 | 9.6 |
| Magnesia B, g | 0 | 0 | 0 | 0 |
| Magnesia C, g | 38.4 | 36 | 30 | 38.4 |

Properties After Static Aging at 150° F. for 16 Hours

| | | | | |
|---|---|---|---|---|
| PV, cp | 18 | 20 | 35 | 19 |
| YP, Pa | 10.56 | 11.52 | 49.9 | 9.6 |
| 10-Sec GS, Pa | 4.32 | 3.84 | 25 | 3.36 |
| 10-Min, GS, Pa | 5.76 | 6.72 | 31.2 | 4.8 |
| LSRV, cp | 20,400 | 20,700 | 248,000 | 13,100 |
| pH | 10.35 | 10.92 | 10.52 | 10.34 |
| Fluid Loss | | | | |
| Spurt Loss, ml | 2.0 | 2.0 | 2.0 | 4.5 |
| 30 min., ml | 10.5 | 12.0 | 12.0 | 12.5 |
| Gelation | None | None | Slight | None |
| Settling | None | None | None | None |
| Separation | None | None | None | ⅜ in |

What is claimed is:

1. A well drilling and servicing fluid comprising an aqueous liquid, a water soluble polymer viscosifier, a polymeric fluid loss control additive, and a particulate magnesia bridging agent wherein the magnesia has an Activity Index greater than about 800 seconds.

2. The fluid of claim 1 wherein the polymer is a biopolymer produced by fermentation of a carbohydrate source by the action of bacteria or fungi which is an excellular polysaccharide having a molecular weight in excess of about 500,000.

3. The fluid of claim 2 wherein the polymer is xanthan gum.

4. The fluid of claim 1 wherein the polymeric fluid loss control additive is selected from the group consisting of pregelatinized starch, starch derivatives, cellulose derivatives, and mixtures thereof.

5. The fluid of claim 1 wherein the polymeric fluid loss control additive is a starch derivative selected form the group consisting of hydroxyethyl starch, hydroxypropyl starch, hydroxyalkyl carboxymethyl starch, carboxymethyl starch, tertiary aminoalkyl ether derivatives of starch, and the slightly crosslinked derivatives of such derivatized starches, and mixtures thereof.

6. The fluid of claim 1 wherein the polymeric fluid loss control additive is a hydroxypropyl ether derivative of starch which has been slightly crosslinked with epichlorohydrin.

7. The fluid of claim 1 wherein the polymeric fluid loss control additive is selected from the group consisting of a crosslinked ether derivative of (1) a partially hydrolyzed starch, (2) a partially depolymerized, crosslinked ether derivative of starch, and (3) mixtures thereof.

8. The fluid of claim 3 wherein the polymeric fluid loss control additive is a hydroxypropyl ether derivative of starch which has been slightly crosslinked with epichlorohydrin.

9. The fluid of claim 3 wherein the polymeric fluid loss control additive is selected from the group consisting of a crosslinked ether derivative of (1) a partially hydrolyzed starch, (2) a partially depolymerized, crosslinked ether derivative of starch, and (3) mixtures thereof.

10. The fluid of claim 1 wherein the Activity Index is from about 800 seconds to about 3000 seconds.

11. The fluid of claim 10 wherein the polymer viscosifier is xanthan gum and wherein the polymeric fluid loss control additive is selected from the group consisting of a crosslinked ether derivative of (1) a partially hydrolyzed starch, (2) a partially depolymerized, crosslinked ether derivative of starch, and (3) mixtures thereof.

12. The process of drilling a well wherein the fluid of claim 1 is circulated within a borehole being drilled as drilling proceeds.

13. The process of drilling a well wherein the fluid of claim 2 is circulated within a borehole being drilled as drilling proceeds.

14. The process of drilling a well wherein the fluid of claim 3 is circulated within a borehole being drilled as drilling proceeds.

15. The process of drilling a well wherein the fluid of claim 4 is circulated within a borehole being drilled as drilling proceeds.

16. The process of drilling a well wherein the fluid of claim 5 is circulated within a borehole being drilled as drilling proceeds.

17. The process of drilling a well wherein the fluid of claim 6 is circulated within a borehole being drilled as drilling proceeds.

18. The process of drilling a well wherein the fluid of claim 7 is circulated within a borehole being drilled as drilling proceeds.

19. The process of drilling a well wherein the fluid of claim 8 is circulated within a borehole being drilled as drilling proceeds.

20. The process of drilling a well wherein the fluid of claim 9 is circulated within a borehole being drilled as drilling proceeds.

21. The process of drilling a well wherein the fluid of claim 10 is circulated within a borehole being drilled as drilling proceeds.

22. The process of drilling a well wherein the fluid of claim 11 is circulated within a borehole being drilled as drilling proceeds.

23. The process of completing or working over a well wherein a subterranean formation is contacted with the fluid of claim 1.

24. The process of completing or working over a well wherein a subterranean formation is contacted with the fluid of claim 2.

25. The process of completing or working over a well wherein a subterranean formation is contacted with the fluid of claim 3.

26. The process of completing or working over a well wherein a subterranean formation is contacted with the fluid of claim 4.

27. The process of completing or working over a well wherein a subterranean formation is contacted with the fluid of claim 5.

28. The process of completing or working over a well wherein a subterranean formation is contacted with the fluid of claim 6.

29. The process of completing or working over a well wherein a subterranean formation is contacted with the fluid of claim 7.

30. The process of completing or working over a well wherein a subterranean formation is contacted with the fluid of claim 8.

31. The process of completing or working over a well wherein a subterranean formation is contacted with the fluid of claim 9.

32. The process of completing or working over a well wherein a subterranean formation is contacted with the fluid of claim 10.

33. The process of completing or working over a well wherein a subterranean formation is contacted with the fluid of claim 11.
